(19) United States
(12) Patent Application Publication
(10) Pub. No.: US 2011/0239774 A1
(43) Pub. Date: Oct. 6, 2011

(54) FATIGUE TESTING A SAMPLE BY CYCLICAL APPLICATION OF UNIDIRECTIONAL STRESS

(76) Inventors: Martin SCHUYLER, Hastings-on-Hudson, NY (US); Thomas F.W. Ferguson, New York, NY (US); Stephen R. Della Vedova, Brightwaters, NY (US)

(21) Appl. No.: 12/754,631

(22) Filed: Apr. 6, 2010

(51) Int. Cl. G01N 3/32

(52) U.S. Cl. 73/812

(57) ABSTRACT

A sample having a known mass and stiffness is rigidly secured to an axially elongated beam having a mass and a stiffness that are very large as compared to the mass and stiffness of the sample. The beam is then caused to resonate in the free-free mode. This subjects the sample to cyclical unidirectional stress. Advantageously, resonance of the beam occurs at an audio frequency, permitting severe fatigue tests requiring tens of millions of cycles to be completed in a relatively short time.

### BACKGROUND OF THE INVENTION

The invention relates to testing apparatus, and more particularly relates to apparatus used to subject samples to fatigue tests. In its most immediate sense, the invention relates to apparatus for fatigue testing a sample by cyclical application of unidirectional stress, thereby causing the sample to undergo cyclical strain.

A heater for a helicopter rotor blade must be highly strain-resistant. As is set forth in U.S. Pat. No. 4,841,124, a helicopter rotor blade is subject primarily to centrifugal and bending forces. For one particular military helicopter rotor blade that is to be provided with a heater, centrifugal force on the blade (and therefore on the heater, which is fixed to the blade) is assumed to cause a maximum longitudinal strain on the order of 1300 microinches per inch (1300 microstrain). However, bending forces are not constant. Normally, a helicopter blade bends as it advances into the wind during one half of its rotation and as it retreats away from the wind during the other half. For this rotor blade and heater, stress from this bending is assumed to add a cyclic longitudinal strain component of about 1250 microstrain. This cyclic component will have a relatively constant frequency of about 5 Hz (corresponding to the approximately constant 300 rpm at which the helicopter rotor is driven). When these effects are combined, the net effect is an overall unidirectional (here, longitudinally extending) strain on the rotor blade and attached heater, which strain varies cyclically at a rate of approximately 5 Hz between 50 and 2550 microstrain.

For a mission-critical element such as a heated helicopter rotor blade, reliability is a prime consideration. For this application, the heater must have a proven ability to survive a fatigue test of 80 million cycles. Such a proof can only occur if samples of the heater remain working after they have been stressed (i.e. subjected to a force of deformation) 80 million times.

Fatigue testing is a well-known technique and equipment is presently manufactured to carry such testing out. However, existing equipment is unsuitable for carrying out such severe fatigue tests. Using conventional materials testing equipment, a fatigue test of 80 million cycles of 1300+/−1250 microstrain might require six months of steady operation. Such a prolonged test is impractical.

There is a need for method and apparatus for fatigue testing a sample by cyclical application of unidirectional stress.

### SUMMARY OF THE INVENTION

The invention proceeds from the realization that existing fatigue testing is based on an inherently slow methodology. A conventional fatigue testing machine holds the sample between a fixed jaw and a moveable jaw and slowly stretches the sample through a precisely calibrated distance. For such an apparatus to complete 80 million cycles while maintaining appropriate dimensional control must necessarily take an impracticably long time.

In accordance with the invention, the sample to be tested is rigidly (advantageously but not necessarily, adhesively) secured to an elongated beam (advantageously but not necessarily, a rectangular beam) with a mass and a stiffness that are very large as compared with the mass and stiffness of the sample under test. Then, the beam is deformed. Advantageously, the beam is caused to resonate, and in the preferred embodiment the beam is caused to resonate in a free-free mode, i.e. in a mode wherein the beam is in resonance and supported only at its vibrational nodes.

Because the sample is rigidly secured to the beam, deformation (strain) of the beam stresses the sample and causes it to experience the same strain that the beam does. By locating the sample appropriately on the beam and selecting the degree to which the beam deforms, the stress applied to the sample, and therefore the degree to which the sample is strained, can be precisely controlled.

Furthermore, by selecting materials and dimensions appropriate for causing the beam to resonate in the free-free mode, resonance can be caused to occur at an audio frequency, advantageously on the order of 50 Hz. As a result, an 80 million cycle fatigue test can be carried out in less than 20 days instead of the six months required using conventional equipment.

### BRIEF DESCRIPTION OF THE DRAWINGS

The invention will be better understood with reference to the following illustrative and non-limiting drawings, in which:

FIG. 1 schematically illustrates a thin beam resonating in a free-free mode;

FIG. 2 schematically illustrates deformation of the center of the beam;

FIG. 3 schematically illustrates application of unidirectional stress to two samples;

FIG. 4 schematically illustrates apparatus in accordance with a preferred embodiment of the invention;

FIG. 5 illustrates one half of a beam support in accordance with a preferred embodiment of the invention;

FIG. 6 schematically illustrates a second embodiment of the invention in which a spring connects a vibration source to the beam;

FIG. 7 schematically illustrates an alternate design for the beam and shows the effect of that design on the shape of the beam in resonance;

FIG. 8 is a flow chart showing a preferred embodiment of a method in accordance with the invention;

FIG. 9 is a flow chart showing a second preferred embodiment of a method in accordance with the invention;

FIG. 10 is a schematic illustration of preloading the beam to test a sample at a cyclically applied unidirectional stress having a nonzero average value;

FIG. 11 is a schematic illustration of apparatus for preloading the beam to test a sample at a cyclically applied unidirectional stress having a nonzero average value;

FIG. 12 is a flow chart showing a preferred embodiment of a method in accordance with the invention, wherein a sample is tested at a cyclically applied unidirectional stress having a nonzero average value; and

FIG. 13 is a block diagram of a control system used in accordance with a preferred embodiment of the invention.

### DETAILED DESCRIPTION OF PREFERRED EMBODIMENTS

In the Figures, the same element is always indicated by the same reference numeral. The Figures are not to scale, and details may be enlarged or eliminated for clarity. Corresponding elements in different embodiments are indicated using primed reference numerals.

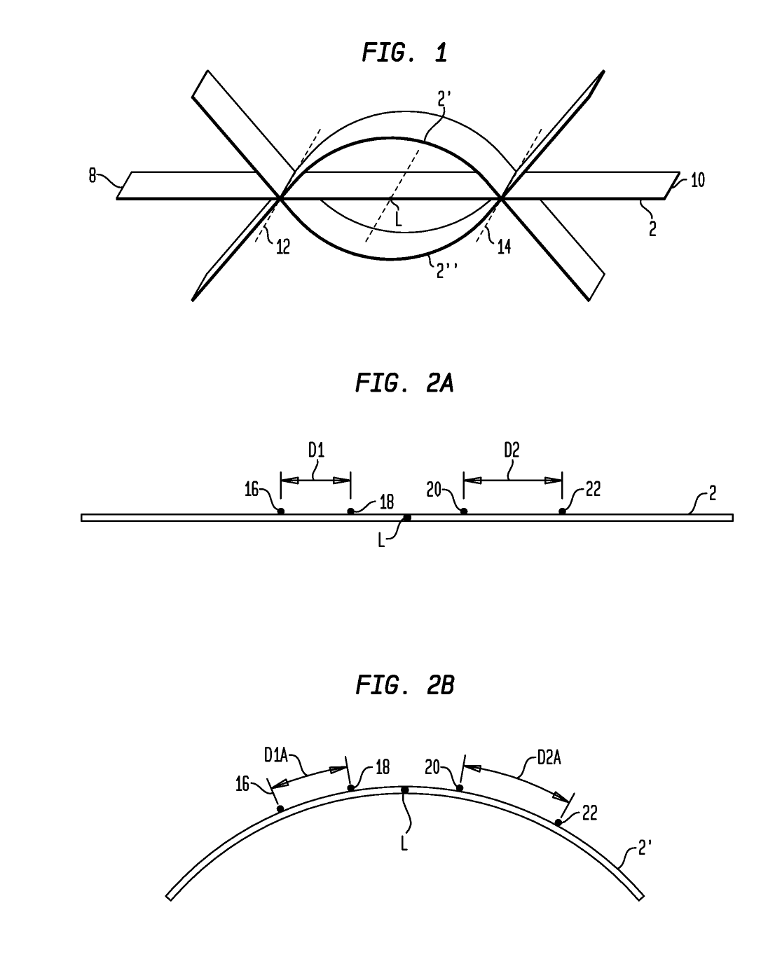

FIG. 1 shows an exemplary beam 2 that is long with respect to its width and thickness. In the preferred embodiment, the beam 2 is made of G10 type fiberglass/epoxy laminate and is 72 inches long, 8 inches wide, and 1.25 inches thick, but these features are not necessary; another material with a high strain fatigue limit, and different dimensions, could be used instead.

Mechanical energy in the form of vibration is supplied to the beam 2 along line L at the center of the beam 2 in order to cause the beam 2 to resonate in its free-free mode. In such resonance, the beam 2 vibrates between the position 2′ and the position 2″. As can be seen in FIG. 1, the ends 8 and 10 of the bar 2 are unconstrained, and the bar 2 is almost motionless at nodes 12 and 14.

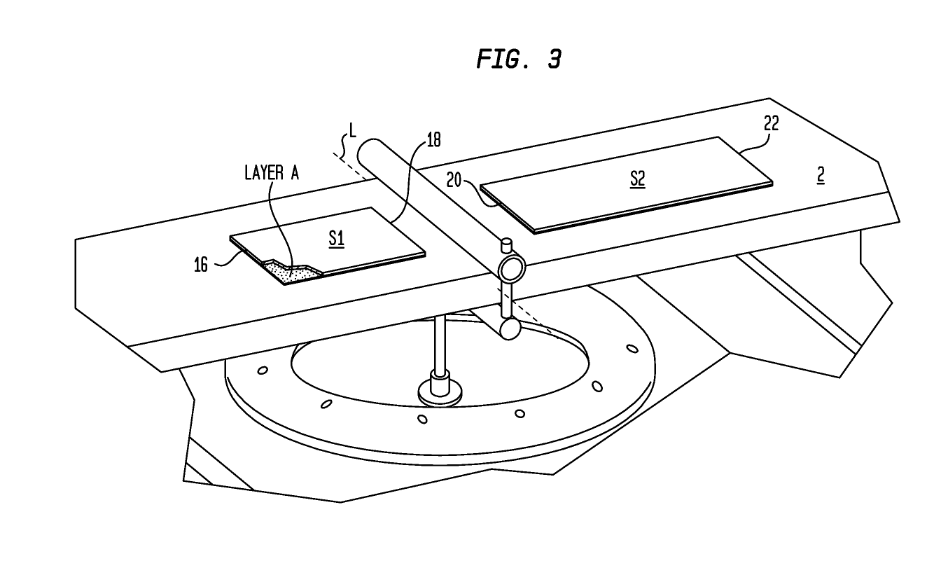

FIG. 2 shows the physical deformation of the beam 2 that occurs about line L when the beam 2 is in resonance in its free-free mode. When the beam 2 is flat (FIG. 2A), points 16 and 18 are spaced apart from each other by distance D1, and points 20 and 22 are spaced apart from each other by distance D2. As is shown in FIG. 2A, the points 16, 18, 20 and 22 are located on the upper surface of the beam 2.

However, when the beam 2 has reached position 2′ (FIG. 2B), the upper surface of beam 2 is slightly longer than it was when it was lying flat. With the beam 2 in position 2′, the distance D1A between points 16 and 18 is slightly longer than the distance D1, and the same is true for the distance D2A between points 20 and 22 with respect to the distance D2. When the beam is in position 2″, the distance D1A between points 16 and 18 is slightly shorter than the distance D1, and the same is true for the distance D2A between points 20 and 22 with respect to the distance D2.

Turning now to FIG. 3, two samples S1 and S2 are rigidly secured to the surface of the beam 2. (The samples S1 and S2 are shown as differently sized. This is because the invention can be used to test a plurality of samples, and the samples need not be identical. However, in practice, a plurality of identical samples will usually be tested simultaneously, since a fatigue test of a single sample may not be statistically sufficient to demonstrate the service life the sample is required to have.) In this example, the samples S1, S2 are attached using a layer of adhesive A, but this is only preferred and other methods could be used instead. (In the preferred embodiment, Hysol EA 956 Epoxy Paste Adhesive was used to attach the samples to the beam, but this is not required and another adhesive could be used instead.) Because the samples S1, S2 are rigidly secured to the beam 2, the samples S1 and S2 are constrained to deform as the beam 2 does. As a result, when the beam 2 is urged from its flat state towards position 2′ by mechanical energy supplied along line L, the bar 2 applies a unidirectional force (stress) to the samples S1 and S2, causing them to elongate (tensile strain). The same thing happens when the beam 2 is urged from its flat state towards position 2″, producing a compressive strain.

It may now be understood that when the beam 2 is caused to resonate in its free-free mode with the samples S1 and S2 rigidly secured to it, unidirectional (longitudinally-extending) stress is cyclically applied to the samples S1 and S2, causing them to cyclically undergo stretching and contraction.

While it is greatly preferred for the beam 2 to be brought to resonance, and for the resonance to be in the free-free mode, this is not absolutely essential. The beam 2 need only be deformed and not caused to resonate, and it would alternatively be possible for the beam 2 to a) be supported at one end and caused to vibrate in the manner of a diving board, or b) to be supported at both ends as mechanical energy is supplied to it. By using free-free mode resonance of the beam 2, the service life of apparatus in accordance with the invention is very long and the apparatus itself becomes not only precisely controllable but also inexpensive.

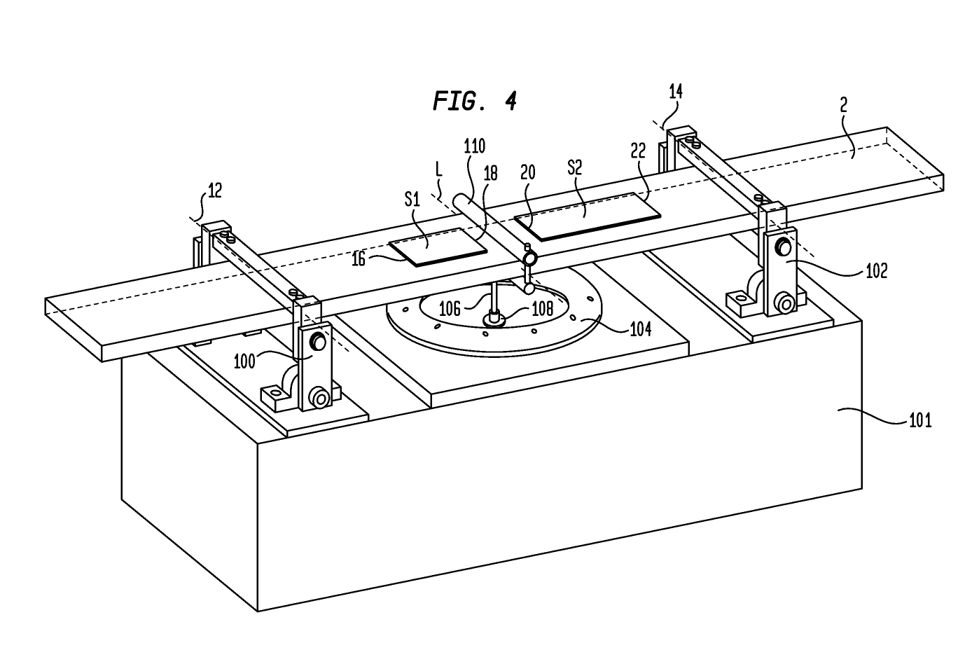

Turning now to FIG. 4, the beam 2 is supported by stands 100 and 102, which are located at the nodes 12 and 14. The stands 100 and 102 are themselves supported by a rigid frame 101. To excite the beam 2 to a state in which it resonates in its free-free mode, mechanical energy in the form of vibration is supplied to it along line L. This occurs using a vibration source 104 (which advantageously but not necessarily is a conventional subwoofer loudspeaker) that is connected to the beam 2 by a rigid link generally indicated by reference numeral 106. Link 106 advantageously but not necessarily has an enlarged end plate 108 at its lower end and a transversely-extending frame 110 at its upper end. The end plate 108 is bonded to the voice coil of the subwoofer loudspeaker 104 and the frame 110 is advantageously clamped to the beam 2 along the line L. It would alternatively (see below) be possible to use another vibration source such as a shaker head instead of a subwoofer loudspeaker, but the use of a subwoofer loudspeaker has proven to be an inexpensive and effective expedient.

As a practical matter, the mass and stiffness of the beam 2 should advantageously be very large as compared to the mass and stiffness of all samples (e.g. samples S1 and S2) taken together. The beam 2 should be chosen to be so stiff and heavy that its free-free mode resonance is observed to be largely unaffected by the presence or absence of samples S1, S2 upon it. As stated above, the beam 2 of the here-described preferred embodiment resonates at 52 Hz with no samples mounted upon it, and with samples mounted upon it the resonant frequency of the beam 2 changes by less than 1 Hz. As long as the ratio of mass and stiffness is sufficient, other methods of attaching the fatigue samples to the beam, such as bolting, can be used to conduct fatigue tests.

The resonant frequency of the beam 2 can be estimated theoretically and then determined more exactly by experiment (advantageously with the samples mounted to it). In this example, the resonant frequency of the beam 2 was approximated using finite element analysis. Then, the subwoofer loudspeaker 104 was driven using a sinusoidal audio signal having the thus-computed resonant frequency and observing the motion of the bar when the frequency of the signal was increased above, and decreased below, that computed frequency. The resonant frequency of the beam 2 is the frequency that produces the maximum amplitude at resonance with power input held constant. (In this example, the estimated resonant frequency of the beam 2 was 50 Hz and the actual resonant frequency of the beam 2 was 52 Hz, and each of the nodes 12 and 14 was located 16.5 inches inwardly of its end of the beam 2.) Once the resonant frequency of the beam 2 has been determined, the stress applied to the specimens S1 and S2 can be adjusted by changing the power used to drive the subwoofer loudspeaker 104. Increasing the power increases the strain on the beam 2 and thus the stress upon, and resulting strain of, the specimens S1 and S2. Decreasing the power has the opposite effect.

G10 type fiberglass/epoxy laminate was chosen as the material for the beam 2 because this material has low internal friction and therefore low damping. The beam 2 is advantageously made of a low damping material because the input power required to keep the beam 2 resonating at a given amplitude is determined by the damping characteristics of the beam 2. By using a material having low damping characteristics, high amplitude resonance of the beam 2 can be obtained with low power input. Additionally, this material has a fatigue-strain limit that is high as compared with the samples that will be tested.

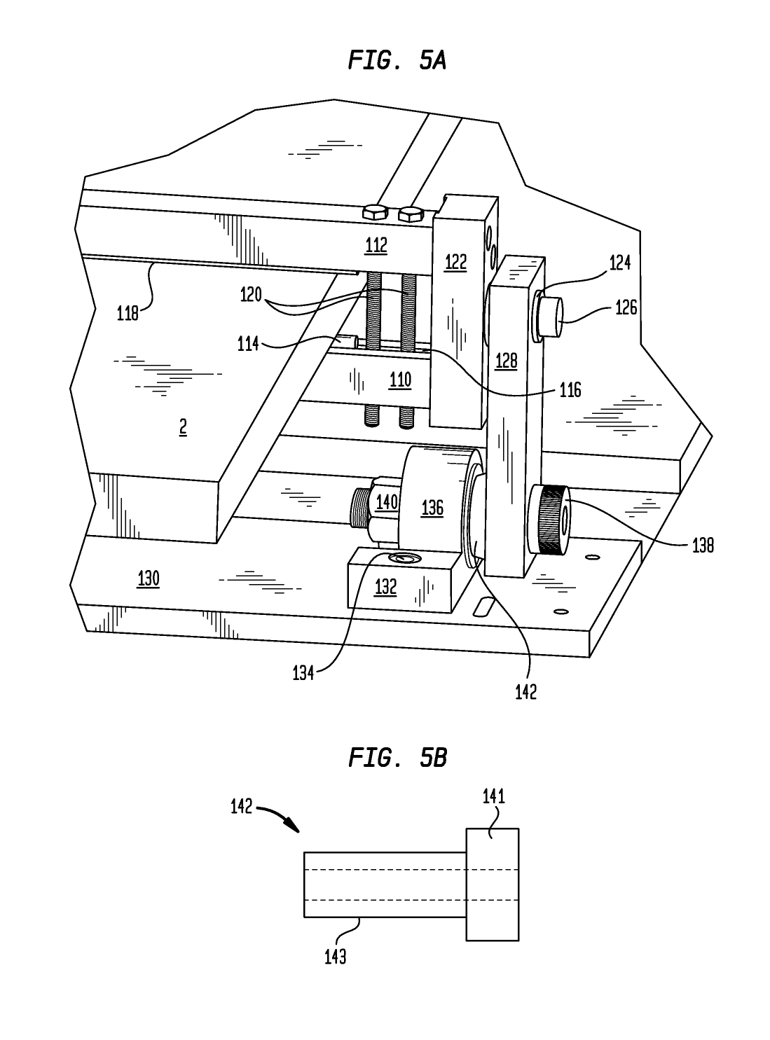

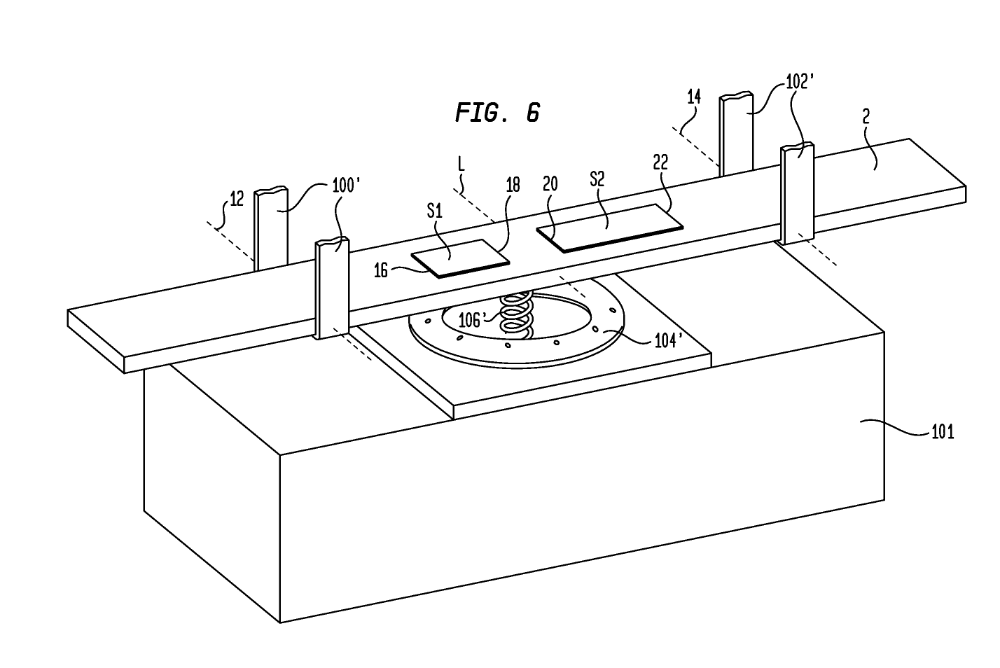

In a preferred embodiment of apparatus in accordance with the invention, the stands 100 and 102 are identical and are symmetrical about the centerline of the beam 2. As can be seen in FIG. 5, each end of each stand 100, 102 has a transversely extending lower jaw 110 and a transversely extending upper jaw 112. A lower rod 114 rests in a mating recess 116 in the lower jaw 110, and an upper rod 118 rests in a like recess (not visible in FIG. 5) in the upper jaw 112. Threaded fasteners 120 clamp the rods 114, 118 tightly against the beam 2, and the stands 100, 102 are so located that the rods 114, 116 are precisely aligned with a corresponding one of the nodes 12, 14.

The jaws 110, 112 are supported by vertically extending elements 122. The elements 122 themselves are fixed to centrally located axles 126 that are rotatably supported within bushings 124 in vertical supports 128.

Each of the vertical supports 128 has a hole at the bottom. A bolt 138 passes through each such hole. Each bolt 138 passes through a resilient bushing 142. Bushing 142 has an enlarged exterior head 141 and a cylindrical body 143; the body is located in the central cavity of a flange 136 and the head 141 is located between the vertical support 128 and the flange 136. The flange 136 is part of a unitary component that is bolted to a baseplate 130 by bolt 134. A nut 140 is threaded to the end of the bolt 138. The nut 140 bears tightly against the cylindrical body of the bushing 142 and the bolt 138 bears tightly against the vertical support 128, whereby the vertical support 128 is held tightly against the bushing 142. The baseplate 130 is attached to the frame 101. It will be understood that by this mechanism, the stands 100 and 102 are fixed at their bottom ends to the frame 101 and at their top ends to the beam 2.

The operation of each of the stands 100, 102 will now be described. When in resonance, the beam 2 is not motionless at nodes 12 and 14. The beam 2 rotates slightly about nodes 12 and 14 and that rotation is accommodated by the rotational support of the axles 126 within the bushings 124. Furthermore, as the beam 2 oscillates in resonance between the positions 2′ and 2″, the axles 126 at nodes 12 and 14 move slightly in the horizontal direction. To increase the service life of the beam 2, this horizontal motion of the axles 126 should be accommodated; if such accommodation is lacking, the excessive constraint on motion of the beam 2 will accelerate the time in which it fails in fatigue.

This accommodation is accomplished by the bushings 142 of the stands 100, 102. No bolt 138 is directly attached to its corresponding flange 136; each bolt 138 rather rests within, and is attached to, its corresponding bushing 142. Because each bushing 142 is resilient, each bushing 142 absorbs the horizontal motion of the beam 2 by allowing vertical support 128 to rotate slightly.

In an overall sense, the function of the stands 100, 102 is to support the beam 2 without exerting any significant resistance to its motion. An alternate structure for doing this is illustrated in FIG. 6. Here, the vibration source 104′ is a vibration head, and vibration from the vibration head 104′ is transmitted to the beam 2 by a spring 106′. Rubber straps 100′ and 102′ support the beam 2 from an overhead support structure (not shown). This structure is presently not preferred. This is because the spring 106′ is subject to fatigue failure whereas the link 106 is not, and the spring 106′ introduces additional undesirable resonances into the control system.

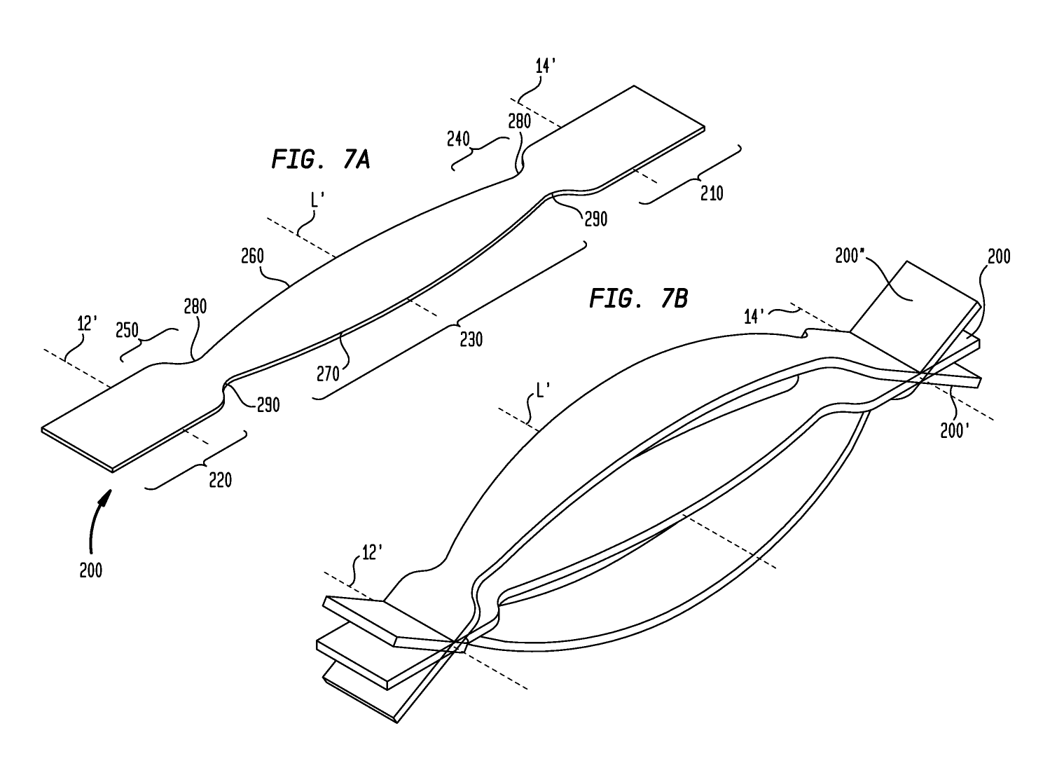

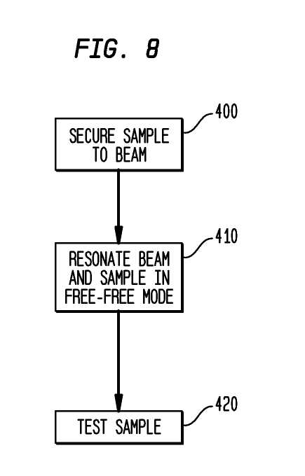

FIG. 7 schematically illustrates an alternate structure for the beam 2. Beam 200 is rectangular as viewed from the side, but as viewed from the top it has two rectangular end regions 210 and 220, a parabolically shaped central region 230, and transition regions 240 and 250 that connect the ends of the central region 230 to the end regions 210 and 220 respectively.

The central region has sides 260 and 270 in the shape of parabolas (as viewed from the top of the beam 200) and transition regions 240, 250 have sides 280 and 290 in the shape of ellipses (likewise as viewed from the top of the beam 200). The reasons for these shapes are discussed below.

In contrast to the beam 2, which has a uniform stiffness along its length, the stiffness of the beam 200 is nonuniform. All else being equal, it is easier to deform a narrower component than a wider one. It may therefore be understood that the stiffness of the beam 200 at any point along its length is determined by its width at that point (the beam 200, like the beam 2, is of material(s) having an invariant stiffness). Wider regions of the beam 200 are stiffer than narrower regions.

The effect of the parabolic shape of the sides 260 and 270 on the behavior of the beam 200 may now be understood. When a vibration source (not shown) is linked to the beam 200 at line L′ and causes the beam 200 to resonate in its free-free mode, narrower regions of the beam 200 deform more than wider regions. The parabolic shapes of the sides 260, 270 are dimensioned such that strain (i.e. deformation) of the central region 230 is substantially the same at all points on its surface. Thus, when the beam 200 is induced to resonate in its free-free mode, many samples can be identically fatigue-tested simultaneously by adhesively securing them all over the central region 230. This is different from the behavior of the beam 2. In the beam 2, strain of the surface varies with position; maximum strain (and therefore maximum stress on a test specimen) occurs in the center of the beam 2 at the line L because that is where minimum bend radius of the beam 2 occurs. As distance from the line L increases, surface strain diminishes.

The sides 280, 290 of the transition regions 240, 250 have elliptical shapes because this will increase the service life of the beam 200. At the ends of the central region 230, the strain of the beam 200 is nonzero. The elliptical shape of the sides 280, 290 serves to smooth the transition to the rectangular sections 210 and 220. Without such smoothing, abrupt variations in internal stress of the beam 200 would eventually cause the beam 200 to fail in fatigue.

Although the stiffness of the beam 200 is made to be nonuniform by suitably choosing the shape of the beam 200, this is only for convenience and is not necessary. It would alternatively be possible to make the beam 200 nonuniformly stiff by varying its composition or its thickness.

A preferred embodiment of a method in accordance with the invention is shown in FIG. 8. In step 400, a sample having a known mass and a known stiffness is rigidly secured to an axially elongated beam having a mass and a stiffness that are very large as compared with the mass and stiffness of the sample. Then, in step 410, the beam is caused to resonate in the free-free mode. This resonance is continued for the time required to subject the sample to the required number of unidirectional stress cycles, and in step 420 the sample is tested to see if it has failed in fatigue.

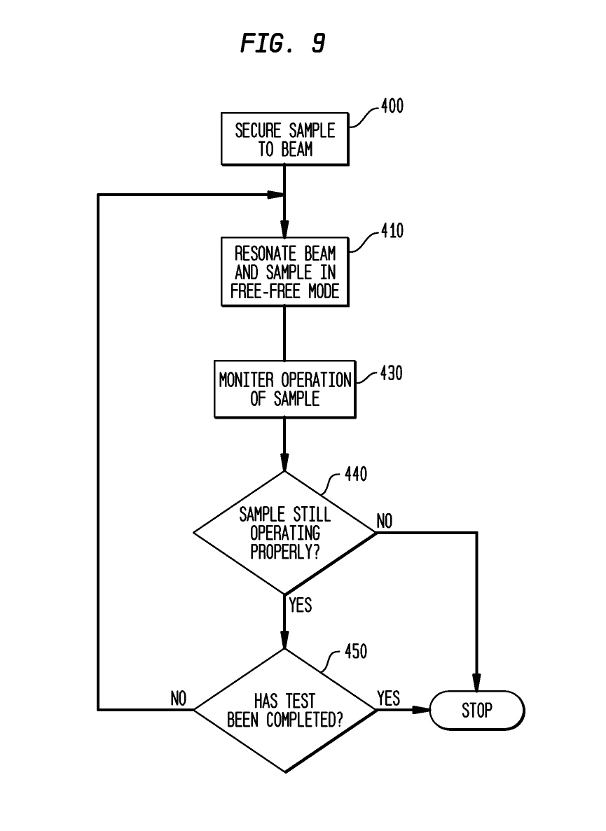

Alternatively, as shown in FIG. 9, in step 430 operation of the sample is monitored while the beam is resonating. This is possible if the sample has an electrical characteristic (e.g. resistance) that can be measured, or if the characteristics of the sample can be otherwise ascertained (as by monitoring heat generated by the sample). (The method by which operation of the sample is monitored is not part of the invention.) In step 440, it is determined whether the sample is continuing to operate as required. If not, the sample has failed in fatigue and the test is stopped. If the sample is continuing to operate as required, it is then determined in step 450 whether the test has continued for the required time. If so, the sample has passed the test and the test is stopped. If not, the test is continued.

The monitoring of the operation of the sample may be carried out continuously or at intervals; this is not a part of the invention.

The above-described method subjects the sample to an average stress of zero. This is because the beam is undeformed when the sample is attached to it, and each unidirectional stress cycle therefore starts from zero, reaches a maximum elongation, passes through zero to reach a maximum compression in the opposite direction, and then reaches zero at the end of the cycle. However, as stated above, a heater for a helicopter rotor blade is assumed to be subjected to a superposition of a) a constant strain caused by centrifugal force and b) a cyclical strain caused by bending forces. Thus, a fatigue test of a helicopter rotor blade heater carried out under conditions of zero average stress would not reflect the conditions under which the heater would actually be used. It would therefore be advantageous to be able to carry out a fatigue test under conditions wherein the average stress was nonzero.

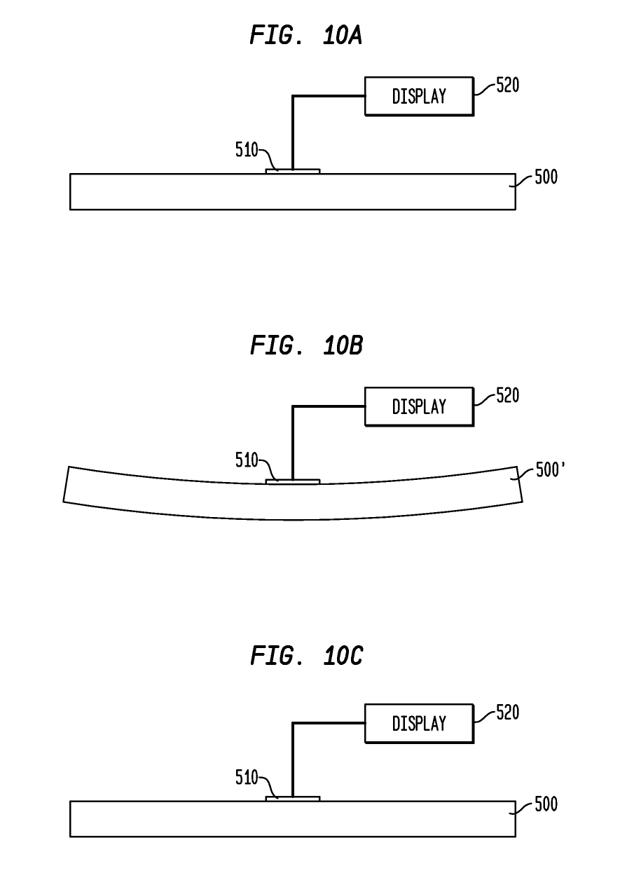

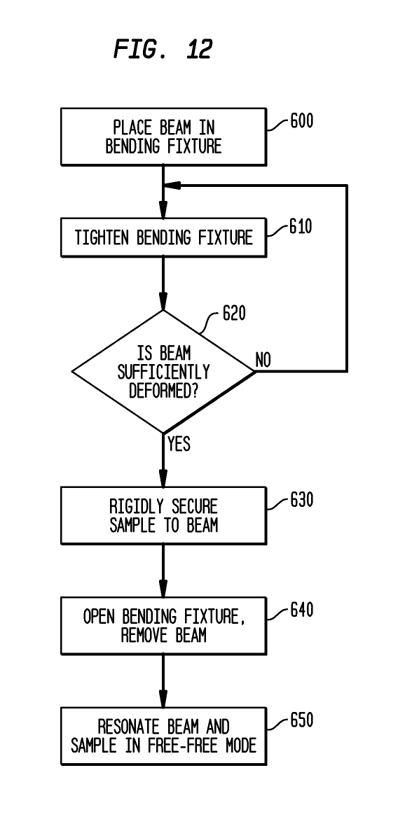

To do this, a method schematically illustrated in FIGS. 10 and 12 is carried out. As is shown in FIG. 10A, an initially flat beam 500 of an appropriate type has a strain gauge 510 attached at the center of its top surface. The beam 500 is subjected to forces that cause it to bow downward (FIG. 10B) until the negative of the desired average strain is read out upon display 520. (FIG. 10B shows the beam 500 in a substantially bowed configuration 500′; in practice, the beam 500 is usually so slightly bowed as to appear flat to the naked eye and FIG. 10B is exaggerated for clarity.) Then, while the beam 500 is in the bowed state illustrated in FIG. 10B, the sample (not shown) is rigidly secured to the top surface of the beam 500 (as by using adhesive that is then allowed to cure). Once this has been accomplished, the forces acting upon the beam 500 are released, allowing the beam 500 to return to its original unbowed state as shown in FIG. 10C.

By attaching the sample to the beam 500 when the beam 500 is bowed in this manner, the sample will be subjected to tensile stress (and therefore strained in tension, i.e. stretched out) when the beam 500 flattens out. In this way, the sample is pre-stressed to the intended degree before testing begins. Thus, when the beam 500 is then caused to resonate in the free-free mode, a steady stress in the desired amount will be superimposed on the cyclical stress produced by resonance of the beam 500.

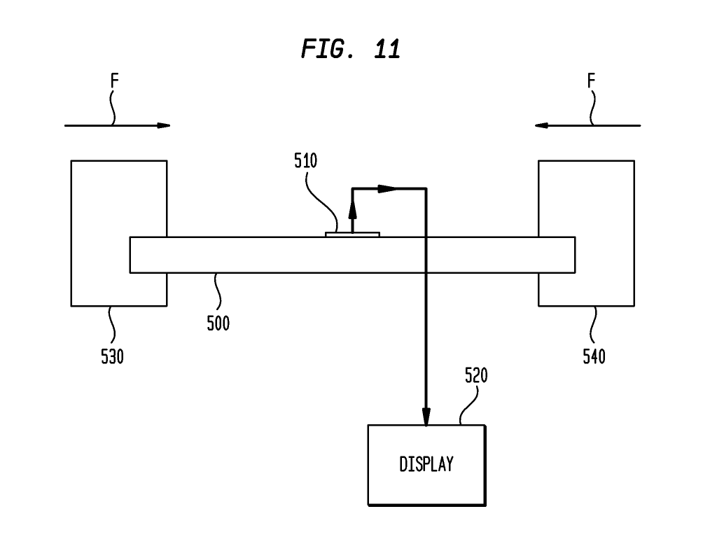

The apparatus schematically shown in FIG. 11 may be used to accomplish the method schematically illustrated in FIG. 10. The beam 500 is held between two jaws 530 and 540 of a bending fixture. The jaws 530, 540 can be pushed toward each other by an appropriate mechanism (not shown), thereby exerting axially-directed forces of compression F, which squeeze the ends of the beam 500 toward each other and cause the beam 500 to bow downward. The strain gauge 510 is mounted to the beam 500, and is connected to the display 520 on which the strain measured by the strain gauge 510 can be read out.

Turning now to FIG. 12, after the beam 500 has been placed in the bending fixture (step 600), the bending fixture is progressively tightened (step 610). Tightening continues until the negative of the desired average strain is read out on display 520 (step 620). Then, in step 630, with the beam 500 bowed, the sample is rigidly secured to the beam 500 (as by adhesive). After step 630 has been accomplished, in step 640 the bending fixture is opened up, thereby releasing the axially directed forces of compression on the beam 500. The beam 500 and attached sample may then be resonated in the free-free mode.

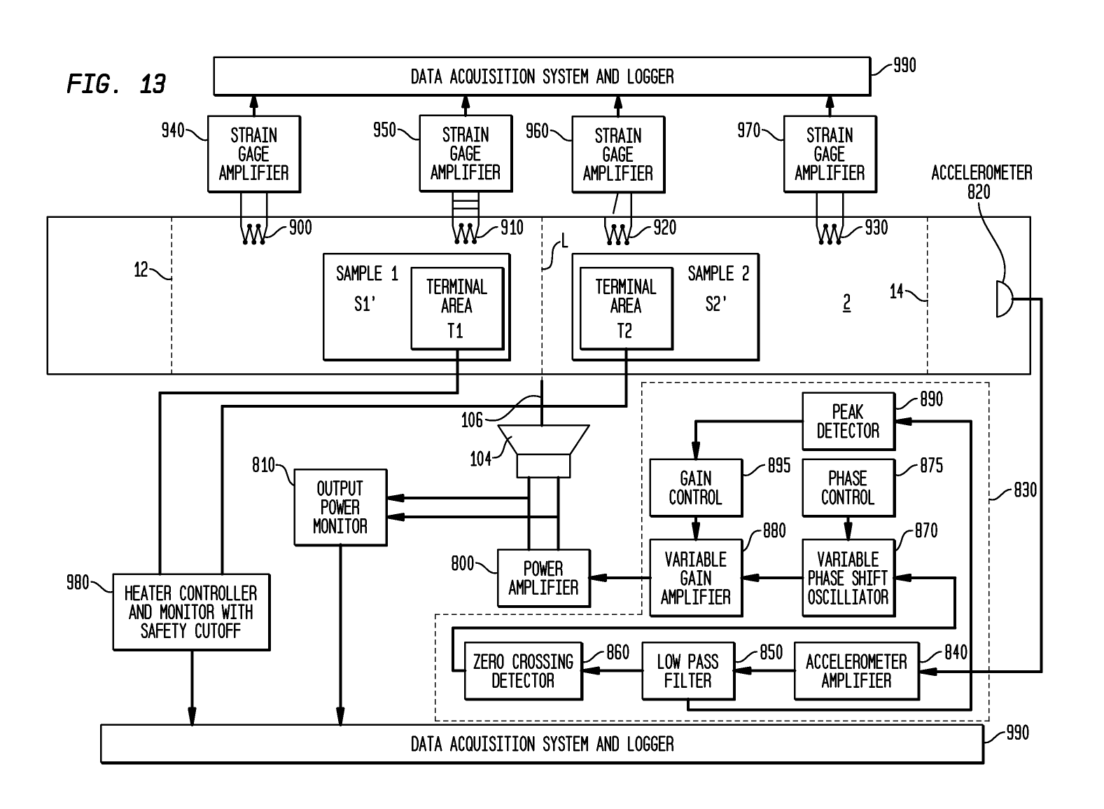

Turning now to FIG. 13, identical samples S1′ and S2′ are adhesively secured to beam 2, which is supported along nodes 12 and 14 by stands 100, 102 (not shown in this Figure). A subwoofer loudspeaker 104 is attached to the beam 2 at line L by link 106 as has been described above.

The control system of apparatus in accordance with a preferred embodiment of the invention is set up to conduct a fatigue test of the samples S1′ and S2′ in such a way as to minimize fatigue of the beam 2. This is done by resonating the beam 2 in the free-free mode at its resonant frequency and at an appropriate amplitude, but driving the subwoofer loudspeaker 104 at a minimum power output from power amplifier 800 as measured by the output power monitor 810, thereby transferring minimum mechanical energy to the beam 2 via the link 106.

To do this, an accelerometer 820 is mounted adjacent one end of the beam 2 and is connected to control circuitry 830, which is used to control the power output from the power amplifier 800. The output from the accelerometer 820 is amplified in amplifier 840 and the output of the amplifier 840 is routed to a low-pass filter 850. As stated above, the resonant frequency of the beam 2 is 52 Hz and the low-pass filter 850 filters out higher harmonics (those with frequencies above approximately 60-70 Hz) to avoid improper triggering of subsequent circuitry. One output of the low-pass filter 850 is connected to a zero-crossing detector 860, and another output of the low-pass filter 850 is connected to a peak detector 890.

The zero-crossing detector 860 produces a signal when the acceleration of the end of the beam 2 is zero (as measured by the output of the accelerometer 820) i.e. when the beam 2 is flat, and the peak detector 890 produces a signal representing the maximum acceleration of the beam 2 as measured by the accelerometer 820. Thus, the signal from the zero-crossing detector 860 represents the phase of oscillation of the beam 2, and the signal produced by the peak detector 890 represents the maximum acceleration of the end of the beam 2, which is related to the maximum displacement of the end of the beam 2.

The output of the zero-crossing detector 860 is input to a variable phase-shift oscillator 870, which produces a sine wave in the audio range (in this example, in a frequency window that includes 52 Hz). The variable phase-shift oscillator 870 is also connected to a phase control 875. The output of the peak detector 890 is then routed through a gain control 895 to be input to a variable gain amplifier 880, which amplifies the output of the variable phase-shift oscillator 870 and directs the amplified output to the power amplifier 800.

The operation of the control circuitry 830 will now be described. First, the circuitry is energized and the frequency of the variable phase-shift oscillator 870 is adjusted until the beam 2 is in resonance. The resonance of the beam 2 occurs at that frequency that maximizes the displacement of the end of the beam 2, so as a practical matter the frequency of the audio sine wave from the variable phase-shift oscillator 870 is tuned to maximize the signal from the peak detector 890. As stated above, in this example the resonant frequency of the beam 2 was initially computed to be 50 Hz but was actually determined to be 52 Hz with samples S1′ and S2′ mounted upon it.

Next, the phase of the audio sine wave from the variable phase-shift oscillator 870 is varied by adjusting the phase control 875. It will be recalled that the signal from the zero-crossing detector 860 represents the phase of oscillation of the beam 2. Adjustment of the phase control 875 causes the phase of the sine wave output from the variable phase-shift oscillator 870 to be advanced or retarded relative to the phase of oscillation of the beam 2. It has been experimentally determined that by appropriately shifting the phase of the signal from the variable phase-shift oscillator 870 relative to the phase of oscillation of the beam 2, the power produced by the power amplifier 800 can be minimized without reducing the amplitude of oscillation at the end of the beam 2. Thus, once the beam 2 has been caused to resonate, the phase control 875 is adjusted to minimize the output from the power amplifier 800 as measured by the output power monitor 810. As a result, resonance of the beam 2 is maintained even when only a minimum quantity of mechanical energy is transferred to the beam 2. This produces the minimum possible wear on the beam 2 and prolongs its service life.

Once the beam 2 has been brought to resonance using minimum power from the power amplifier 800, the amplitude of the oscillation of the beam 2 is adjusted to produce the desired cyclic stress on the samples S1′ and S2′. This is done by adjusting the gain control 895, which causes the output of the variable gain amplifier 880 (and thus the output from the power amplifier 800) to increase (increasing the amplitude of oscillation of the beam 2) or to decrease (decreasing the amplitude of oscillation of the beam 3). Strain gauges 900, 910, 920, and 930 are mounted to the beam 2 and are connected via strain gauge amplifiers 940, 950, 960, and 970 to a data acquisition system 990, and the gain control 895 is adjusted until the amplitude of the cyclic stress applied to samples S1′ and S2′ produces appropriate strain of the beam 2 as measured by the strain gauges 900, 910, 920, and 930.

In this example, the samples S1′ and S2′ are electrical heaters supplied with power at terminal areas T1 and T2 respectively. A controller 980 controls power to the samples S1′ and S2′ and the operation of the samples S1′ and S2′ is monitored by the data acquisition system 990.

When either or both of the samples S1′ and S2′ fail in fatigue, it (or they) short-circuits and overheats. This can cause a fire. For this reason, infra-red detectors (not shown) are mounted on a frame (also not shown) above the samples S1′ and S2′ and are connected to the controller 990. When a sample S1′ or S2 overheats as a result of a fatigue failure, the controller 980 shuts off the power to that sample to avoid causing a fire.

The controller 980 and above-described infra-red detectors are not part of the invention. They are provided only because the samples S1′ and S2′ are electrical heaters.

Although at least one preferred embodiment of the invention has been described above, this description is not limiting and is only exemplary. The scope of the invention is defined only by the claims, which follow:

1. An apparatus for fatigue testing a sample by cyclical application of unidirectional stress, the sample having a known mass and a known stiffness, the apparatus comprising:
an axially elongated beam having a mass and a stiffness that are very large as compared to the known mass and stiffness of the sample;
means for rigidly securing the sample to the beam; and
means for deforming the beam.

2. The apparatus of claim 1, wherein the means for deforming the beam comprises means for causing the beam to resonate.

3. The apparatus of claim 2, wherein the means for causing the beam to resonate comprises means for causing the beam to resonate in a free-free mode.

4. The apparatus of claim 1, wherein the beam has a uniform stiffness.

5. The apparatus of claim 1, wherein the beam has a nonuniform stiffness.

6. The apparatus of claim 1, wherein the beam is rectangular.

7. The apparatus of claim 1, wherein the beam has a central region having parabolically shaped sides.

8. The apparatus of claim 1, wherein said means for rigidly securing is adhesive.

9. The apparatus of claim 1, wherein said means for deforming the beam comprises a vibration source and a spring, the spring connecting the beam to the vibration source.

10. The apparatus of claim 1, wherein said means for deforming the beam comprises a vibration source and a rigid element connecting the beam to the vibration source.

11. The apparatus of claim 10, wherein the vibration source is a subwoofer loudspeaker.

12. The apparatus of claim 1, wherein the means for deforming the beam comprises means for supporting the bar at its resonant nodes.

13. The apparatus of claim 10, further comprising:
means for providing energy to the vibration source; and
means for minimizing energy consumed by the vibration source when the beam is resonating in a free-free mode.

14. The apparatus of claim 13, wherein:
the vibration source is an electromechanical transducer;
the means for providing energy comprises an oscillator operating at an audio frequency; and
the means for minimizing energy comprises means for phase-shifting the output of the oscillator.

15. A method for fatigue testing a sample by cyclical application of unidirectional stress, the sample having a known mass and a known stiffness, the method comprising the following steps:
rigidly securing the sample to an axially elongated beam having a mass and a stiffness that are very large as compared to the known mass and stiffness of the sample; and
deforming the beam.

16. The method of claim 15, wherein the step of deforming the beam comprises the step of causing the beam to resonate.

17. The method of claim 16, wherein the step of causing the beam to resonate comprises the step of causing the beam to resonate in the free-free mode.

18. The method of claim 13, further comprising the steps of:
deforming the beam before said rigidly securing step; and
allowing the beam to assume its undeformed state after said rigidly securing step and before the step of deforming the beam.

19. A method for fatigue testing a sample by cyclical application of unidirectional stress having a nonzero average value, the sample having a known mass and a known stiffness, comprising the following steps performed in order:
obtaining an axially elongated beam having a mass and a stiffness that are very large as compared to the known mass and stiffness of the sample;
applying deforming the beam;
rigidly securing the sample to the deformed beam;
allowing the beam to resume its undeformed state; and
causing the beam to resonate in a free-free mode.

20. The method of claim 19, wherein the step of deforming the beam is carried out until the measured strain of the beam is the negative of the desired average strain.

21. An apparatus for fatigue testing a sample by cyclical application of unidirectional stress, the sample having a known mass and a known stiffness, the apparatus comprising:
an axially elongated beam having a mass and a stiffness that are very large as compared to the known mass and stiffness of the sample;
means for rigidly securing the sample to the beam; and
means for causing the beam to resonate in a free-free mode.

22. A method for fatigue testing a sample by cyclical application of unidirectional stress, the sample having a known mass and a known stiffness, the method comprising the following steps:
rigidly securing the sample to an axially elongated beam having a mass and a stiffness that are very large as compared to the known mass and stiffness of the sample; and
causing the beam to resonate in a free-free mode.
